(19) United States
(12) Patent Application Publication
(10) Pub. No.: US 2002/0176670 A1
(43) Pub. Date: Nov. 28, 2002

(54) Connector ferrule for connecting optical fibers

(76) Inventors: Masao Shinoda, Tokyo (JP); Katsuki Suematsu, Tokyo (JP); Takashi Shigenaga, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/144,100

(22) Filed: May 9, 2002

(30) Foreign Application Priority Data
May 10, 2001 (JP) 2001-140046
May 10, 2001 (JP) 2001-140047
Feb. 8, 2002 (JP) 2002-32567
Feb. 15, 2002 (JP) 2002-38500

(51) Int. Cl. G02B 6/36

(52) U.S. Cl. 385/80; 385/78

(57) ABSTRACT

A ferrule for optical connector has a block-shaped body, and multiple fiber holes are formed in this body. A filler pit for filling adhesive is formed in the body, and extends from an opening formed on an outer surface of the body toward the inside of the body to communicate to inner ends of the fiber holes inside the body. The multiple fiber holes are formed as multiple stages. The inner ends of these fiber holes on the second and upper stages are positioned in a range of the opening while the opening is viewed as the upper side. Alternatively, guide grooves are provided so as to communicate to the ends of the fiber holes for guiding optical fibers into the fiber holes, and ends of these guide grooves are positioned in the range of the opening.

### BACKGROUND OF THE INVENTION

1. Field of the Invention

The present invention relates to an optical connector for connecting optical fibers used for optical communication with each another.

2. Description of the Related Art

A plastic ferrule for an optical connector used for optical communication has been developed for increasing the number of fibers and increasing the density of the optical fibers, increasing the precision for a butt-connection, and reducing the price by mass production. For example, the plastic ferrule holds multiple optical fibers while rows of optical fibers are piled up as multiple stages, and forms a matrix-like optical fiber array on a joint facet. Specifically, (m) of rows of the fiber holes comprises one stage, and (n) of stages are piled up to form an (m)×(n) fiber hole array.

### SUMMARY OF THE INVENTION

The present invention disclosed and claimed herein, in one aspect thereof, comprises a ferrule. The ferrule comprises: a block-shaped body having a front facet and a rear facet; two pin holes provided on the front facet, the pin holes extending in a front-to-rear direction in the body for individually allowing a guide pin to be inserted thereinto; a fiber hole array having multiple fiber holes provided between the two pin holes on the front facet, extending in the front-to-rear direction in the body, for individually allowing an optical fiber to be inserted thereinto and passed therethrough, the multiple fiber holes forming a row of the multiple fiber holes in a direction virtually in parallel with a direction of a line connecting centers of the two pin holes with each other, the multiple fiber holes forming multiple stages of these rows in a direction virtually perpendicular to the direction of the line connecting the centers of the two pin holes with each other; an introduction opening formed on the rear facet, for introducing optical fibers; a cavity extending from the introduction opening to inner ends of the multiple fiber holes in the front-to-rear direction of the body, for storing a part of the optical fibers; an adhesive filler opening formed on a side surface of the body, for filling the inside of the body with an adhesive; and a filler pit extending from the adhesive filler opening to the inside of the body to communicate to the cavity, for positioning the inner ends of the fiber holes on the second and upper stages in a range of the adhesive filler opening while the adhesive filler opening is viewed as the upper side. Alternately, the filler pit positions ends of guide grooves in the range of the adhesive filler opening. The guide grooves are formed so as to communicate to the inner ends of the fiber holes, for guiding the insertion of the optical fibers into the fiber holes.

Further scope of applicability of the present invention will become apparent from the detailed description given hereinafter. However, it should be understood that the detailed description and specific example, while indicating preferred embodiment of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 is a plan view of a ferrule of a first embodiment;

FIG. 2 is a sectional view of the ferrule taken along the line II-II in FIG. 1;

FIG. 3 is a plan view of a conventional ferrule;

FIG. 4 is a sectional view of the conventional ferrule taken along the line IV-IV in FIG. 3;

FIG. 5 is a sectional view of a conventional optical connector taken along the line V-V in FIG. 3;

FIG. 6 is a plan view of a ferrule of a second embodiment;

FIG. 7 is a sectional view of the ferrule taken along a line IV-IV in FIG. 6;

FIG. 8 is a perspective view of an optical fiber applicator;

FIG. 9 is a perspective view showing an application example of the optical fiber applicator;

FIG. 10 is a sectional view showing a state where a base plate of the applicator in FIG. 8 is inserted into a ferrule;

FIG. 11 is a sectional view showing an operation of inserting an optical fiber into a fiber hole using a guide groove formed on the base plate in the state shown in FIG. 10;

FIG. 12 is a perspective view of an optical fiber applicator different in form from that in FIG. 8;

FIG. 13 is a sectional view showing an operation of inserting an optical fiber into a fiber hole using the applicator shown in FIG. 12;

FIG. 14 is a plan view of a ferrule of a third embodiment;

FIG. 15 is a sectional view of the ferrule taken along the line XV-XV in FIG. 14;

FIG. 16 is a sectional view of a ferrule of a fourth embodiment; and

FIG. 17 is a sectional view showing a state where a base plate of the applicator in FIG. 8 is inserted into a ferrule different from that in FIG. 10.

### DETAILED DESCRIPTION

A body of a ferrule is composed of a plastic molded body, for example. Thermosetting resin such as epoxy resin and thermoplastic resin such as PPS (polyphenylene sulfide) are suitable as a material of the plastic molded body.

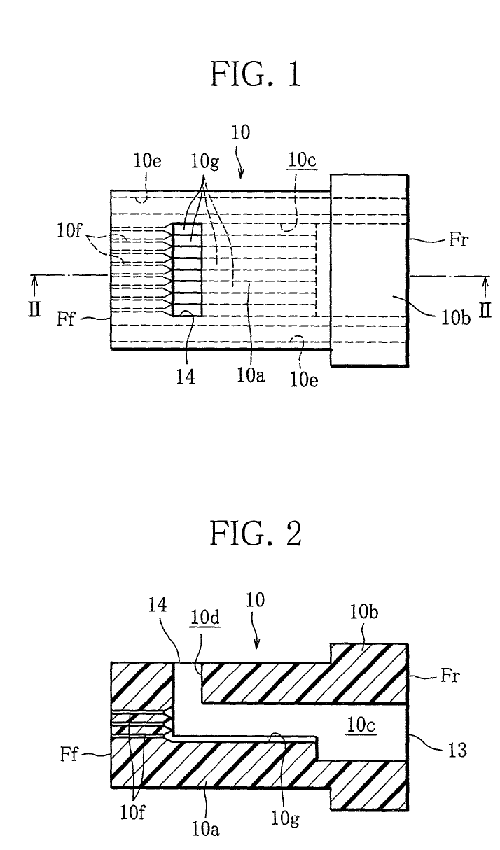

A ferrule 10 according to a first embodiment is shown in FIG. 1 and FIG. 2. This ferrule 10 has a block-shaped body 10a. The body 10a has a front facet Ff and a rear facet Fr respectively on the front and rear sides in the lengthwise direction. A collar 10b is formed on a rear part of the body 10a. The collar 10b is projected outward as a step from the outer surface more than the other part of the body 10a. An introduction opening 13 is formed on the rear facet Fr of the body 10a. A cavity 10c extending from the introduction opening 13 in a front-to-rear direction is formed approximately at the center of the body 10a. The cavity 10c communicates to multiple fiber holes 10f and a filler pit 10d described later.

An adhesive filler opening 14 is formed on a top surface of the body 10a. The filler pit 10d is formed from this adhesive filler opening 14 toward the inside of the body 10a. The filler pit 10d communicates to the cavity 10c inside the body 10a.

A pair of pin holes 10e are formed in the lengthwise direction in the body 10a. Guide pins described later are inserted into these pin holes 10e respectively. The 24 fiber holes 10f are formed in a front part of the body 10a between the two pin holes 10e. Optical fibers are inserted into the individual fiber holes 10f. The eight fiber holes 10f form one row, and three rows are piled up as three stages in the vertical direction to constitute a matrix array.

As shown in FIG. 2, ends of the fiber holes 10f arranged as the three stages communicate to the cavity 10c. The ends on the second and upper stages, namely on the middle and top stages, are positioned in a range of the adhesive filler opening 14 while the adhesive filler opening 14 is viewed as the upper side. On the other hand, as shown in the drawing, guide grooves log for guiding optical fibers are formed so as to communicate to the fiber holes 10f on the bottom stage while the adhesive filler opening 14 is viewed as the upper side. These guide grooves 10g extend toward the introduction opening 13 in the cavity 10c. The ends of the fiber holes 10f on the middle and top stages communicating to the cavity 10c are located at the same position in the front-to-rear direction.

Optical fibers (bare fibers) whose coating is removed at the end are inserted into the cavity 10c of the ferrule 10 constituted as described above through the introduction opening 13. Adhesive is filled in the filler pit 10d from the adhesive filler opening 14 while the optical fibers are respectively inserted into the individual fiber holes 10f. As a result, the optical fibers are fixed to the ferrule 10 while the optical fibers are inserted into the individual fiber holes 10f of the ferrule 10 to obtain an optical connector used for optical communication.

The following comparison with a conventional example more clearly shows advantages of the ferrule 10 according to the first embodiment.

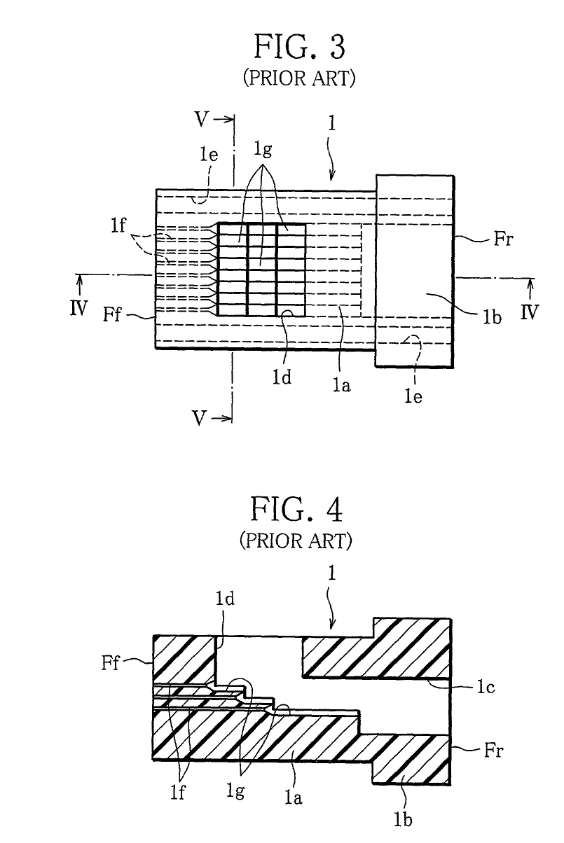

FIG. 3 and FIG. 4 show an example of a conventional ferrule 1. A collar 1b is formed on a rear part of a body 1a of the ferrule 1. A cavity 1c extending in the front-to-rear direction is formed approximately at the center of the body 1a. The cavity 1c has an opening on a rear facet Fr of the body 1a. An opening 1d is formed on a top surface of the body 1a. This opening is referred to as a filler window for filling adhesive. A pair of pin holes 1e for allowing a guide pin to be inserted thereinto are formed in the lengthwise direction on the both sides of the body 1a. Fiber holes 1f for allowing optical fibers to be inserted thereinto are formed between the pair of pin holes 1e at a front part of the body 1a. Eight of these fiber holes 1f constitute one row. These rows are vertically piled as three stages while these stages are displaced as stairs. Guide grooves 1g for guiding optical fibers are formed for the fiber holes 1f on the individual stages.

For the conventional ferrule 1, optical fibers are inserted into the fiber holes 1f on the individual stages along the guide grooves 1g formed while displaced as stairs. Adhesive is filled from the filler window, and is hardened to provide a conventional optical connector.

The conventional ferrule 1 described above has the following problems.

Specifically, core pins are used to form the fiber holes 1f during resin molding. A longer core pin tends to be deformed more under the pressure of the resin. When the fiber holes 1f are formed while displaced as stairs, the overall length increases as the fiber holes 1f are placed on a lower stage. Accordingly, the length of the core pin increases as the fiber holes 1f on a lower stage is formed. As a result, the core pin is deformed under the resin pressure, and the formed fiber hole 1f may be bent.

When an optical fiber is inserted into the ferrule 1, this operation is conducted while the inside of the body 1a is visually observed from the opening 1d. As the number of the stages of the fiber holes 1f increases, it is necessary to increase the size of the opening 1d in the front-to-rear direction. If the opening 1d is excessively large, an absence or an existence of the molded resin on the side of the opening, or on its opposite side deteriorates balance of resin shrink after molding, and the positional accuracy of the fiber holes 1f and the pin holes 1e decreases.

To solve the problem above, the length of the core pins may be decreased to prevent the bend of the core pins caused by the resin molding. When the opening 1d is moved toward the front facet Ff of the ferrule, the lengths of the fiber holes 1f may be decreased accordingly.

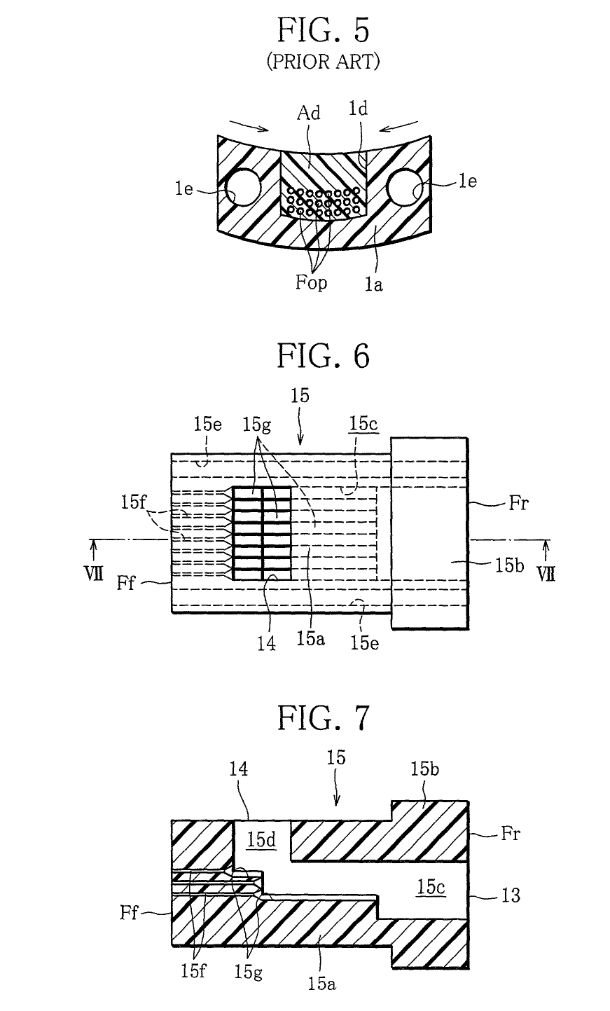

However, this method is not optimal. When optical fibers Fop are inserted into the fiber holes 1f, and are fixed by adhesive, a difference in coefficient of linear expansion between synthetic resin constituting the ferrule 1 and the adhesive Ad causes a warpage on the side of the front facet Ff where the opening 1d exists as shown in FIG. 5. When this warpage is generated, a connection loss increases in the optical connector using the ferrule 1.

On the other hand, the ferrule 10 of the first embodiment solves the conventional problems, and has advantages over the conventional ferrule 1. When the ferrule 10 is viewed while the adhesive filler opening 14 of the body 10a is facing upward, the fiber holes 10f are formed vertically as three stages. The ends of the fiber holes 10f on the second and the upper stages open in the cavity 10c in a range within the adhesive filler opening 14. As a comparison between FIG. 2 and FIG. 4 clearly shows, because the fiber holes 10f are shorter than those of the conventional ferrule 1 on the lower two stages, and have the same length on the three stages of fiber holes 10f, short core pins can be used during the resin molding. Thus, since the resin pressure bends the core pins for the ferrule 10 more seldom than for the ferrule 1 during the molding, the fiber holes 10f are molded at high precision. Further, since the ferrule 10 has the smaller adhesive filler opening 14 and the filler pit 10d then the conventional ferrule 1, even if there is a difference in coefficient of linear expansion between the synthetic resin constituting the ferrule 10 and the adhesive, a generation of the warpage on the front facet Ff where the adhesive filler opening 14 is located is restrained.

The following section describes a ferrule according to a second embodiment.

A ferrule 15 according to the second embodiment is shown in FIG. 6 and FIG. 7. This ferrule 15 has a block-shaped body 15a. The body 15a has a front facet Ff and a rear facet Fr respectively on the front and rear sides in the lengthwise direction. A collar 15b is formed on a rear part of the body 15a. The collar 15b is projected outward as a step from the outer surface more than the other part of the body 15a. An introduction opening 13 is formed on the rear facet Fr of the body 15a. A cavity 15c extending from the introduction opening 13 in the front-to-rear direction is formed approximately at the center of the body 15a. The cavity 15c communicates to multiple fiber holes 15f and a filler pit 15d.

An adhesive filler opening 14 is formed on a top surface of the body 15a. The filler pit 15d is formed from this adhesive filler opening 14 toward the inside of the body 15a. The filler pit 15d communicates to the cavity 15c inside the body 15a.

A pair of pin holes 15e are formed in the lengthwise direction in the body 15a. Guide pins described later are inserted into these pin holes 15e respectively. The 24 fiber holes 15f are formed in a front part of the body 15a between the two pin holes 15e. Optical fibers are inserted into the individual fiber holes 15f. The eight fiber holes 15f form one row, and three rows are piled up as three stages in the vertical direction to constitute a matrix array.

As shown in FIG. 7, guide grooves 15g for guiding optical fibers piled up as the three stages are provided so as to communicate to the fiber holes 15f on the third stage, namely on the top stage, while the adhesive filler opening 14 is viewed as the upper side. These guide grooves 15g extend from the corresponding fiber holes 15f toward the introduction opening 13 in the filler pit 15d, and all of their ends are positioned within a range of the adhesive filler opening 14 with respect to the front-to-rear direction of the body 15a. On the other hand, the ends of the fiber holes 15f on the middle and the bottom stages communicate to the cavity 15c, and are positioned in the middle of the range of the adhesive filler opening 14 with respect to the front-to-rear direction of the body 15a. The guide grooves 15g for guiding optical fibers are formed so as to communicate to the fiber holes 15f on the bottom stage as shown in the drawing. These guide grooves 15g extend toward the introduction opening 13 in the cavity 15c.

The ferrule 15 constituted as described above is assembled as an optical connector as the ferrule 10. Since the ferrule 15 has the adhesive filler opening 14 smaller than the opening 1d of the ferrule 1, even if there is a difference in coefficient of linear expansion between synthetic resin constituting the ferrule 15 and the adhesive, a generation of a warpage on the front facet Ff where the adhesive filler opening 14 is located is restrained. The fiber holes 15f on the bottom stage of the three stages in the ferrule 15 are shorter than the fiber holes 1f on the bottom stage in the conventional ferrule 1. The resin pressure bends core pins for the ferrule 15 more seldom than for the ferrule 1 during the molding. This effect becomes more remarkable because the adhesive filler opening 14 of the ferrule 15 is smaller than the opening 1d of the ferrule 1. Thus, the fiber holes 15f are formed at high precision in the ferrule 15.

The following describes an operation for inserting optical fibers into the individual fiber holes of the ferrules of the individual embodiments. For example, for the ferrule 15, optical fibers are inserted into the fiber holes 15f, which do not have the guide groove 15g, on the middle stage following the steps below.

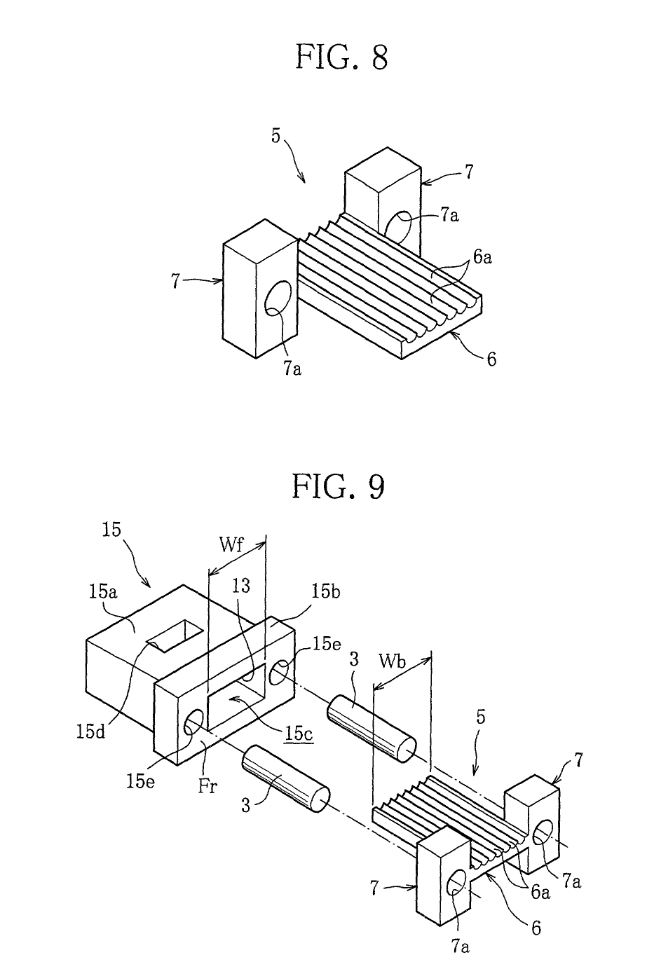

FIG. 8 and FIG. 9 show an optical fiber applicator 5 suitable for inserting optical fibers. The applicator 5 is provided with a base plate 6 and a pair of pin holders 7 formed on the both sides of the base plate 6.

The base plate 6 is composed of a rectangular plate with a constant thickness, and the individual pin holders 7 have a quadratic prism shape as shown in FIG. 8. The pair of pin holders 7 are separated by the width of the base plate 6. The side edges of the base plate 6 are individually attached to the opposing side surfaces of the pin holders 7. The base plate 6 is positioned approximately in the middle of the pin holders 7 in the vertical direction, and protrudes in one direction between the pair of the pin holders 7. Multiple guide grooves 6a are formed for guiding optical fibers on the top surface of the base plate 6. These guide grooves 6a extend in parallel with one another. While the guide grooves 6a are U-grooves in an example shown in FIG. 8 and FIG. 9, they may be V-grooves. An insertion hole 7a into which the guide pin 3 is inserted is formed in the front-to-rear direction in the individual pin holders 7.

The applicator 5 faces the rear facet Fr of the ferrule 15 with a protruded end of the base plate 6 in the lead as shown in FIG. 9. The width Wb of the base plate 6 is set smaller than the width Wf of the cavity 15c and the introduction opening 13 of the ferrule 15 (Wf>Wb). Thus, the base plate 6 is inserted into the cavity 15c through the introduction opening 13. When the base plate 6 is inserted into the cavity 15c, the individual guide grooves 6a are positioned on the same lines as the individual fiber holes of the ferrule 15 are on.

Multiple types of applicators 5 constituted as described above are provided in advance according to the number of stages of the fiber holes, and the number of the fiber holes on the individual stages of the ferrule. When the applicator 5 is used for the ferrule 15, the pair of guide pins 3 are provided as shown in FIG. 9. The base plate 6 is inserted into the cavity 15c of the ferrule 15, the individual guide pins 3 are inserted into the pin holes 15e of the ferrule 15, and the insertion holes 7a of the pin holders 7 to position the applicator 5 with respect to the ferrule 15.

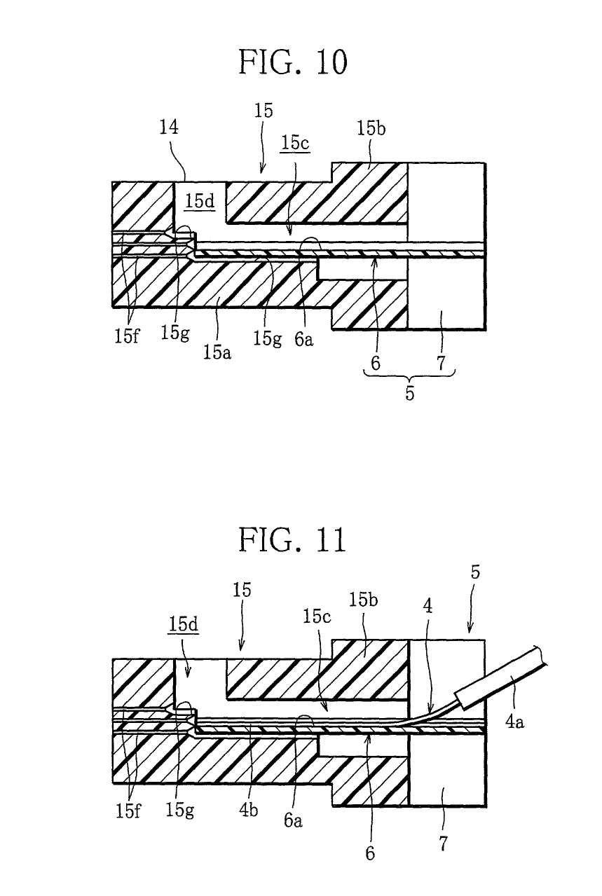

FIG. 10 shows a state where the applicator 5 is combined with the ferrule 15. The base plate 6 of the applicator 5 is placed on upper edges of the guide grooves 15g on the bottom stage. The individual guide grooves 6a coincide with the fiber holes 15f on the middle stage.

In this state, a coating 4a is removed from the tip of the optical fiber 4 for exposing a bare fiber 4b, the bare fiber 4b is introduced into the cavity 15c while the bare fiber 4b is guided by the guide groove 6a as shown in FIG. 11. When the applicator 5 is used, the bare fiber 4b are guided by the individual guide grooves 6a, and are inserted smoothly and easily into the fiber holes 15f on the middle stage even if guide grooves are not formed in the ferrule 15.

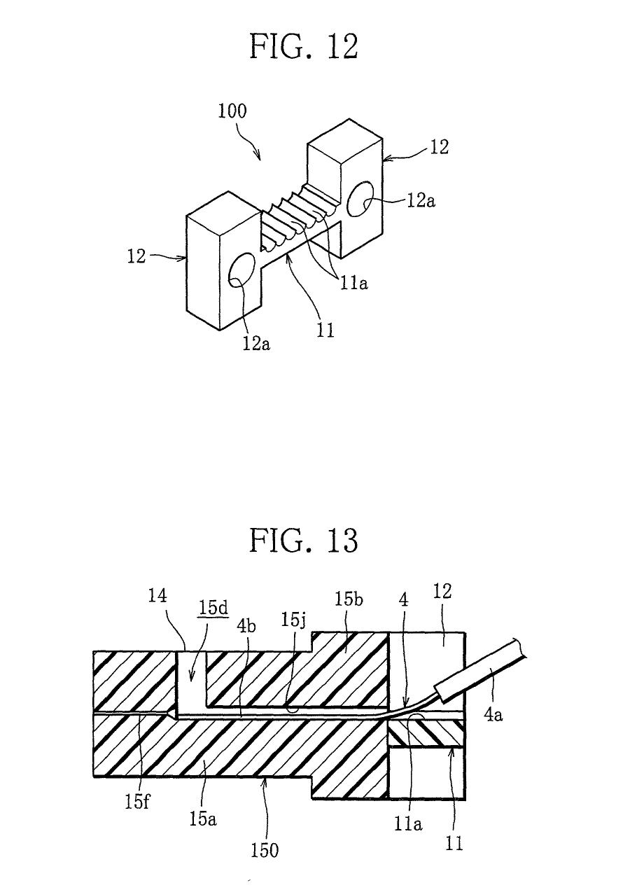

When only the fiber holes are formed and the cavity is not formed in a ferrule, an applicator 100 shown in FIG. 12 is used.

The applicator 100 is provided with a base plate 11 and pin holders 12 formed on the both sides of the base plate 11. Multiple guide grooves 11a are provided on the base plate 11. An insertion hole 12a through which the guide pin 3 is inserted is formed in the pin holders 12. The length of the base plate 11 is the same as the width of the pin holder 12.

The guide pins 3 are inserted through the pin holes (not shown) of the ferrule 150, and the insertion holes 12a of the pin holder 12, and the applicator 100 is positioned with respect to the ferrule 150 as the applicator 5 is. When the bare fibers 4b are being introduced into the guide holes 15j while the bare fibers 4b are guided by the guide grooves 11a as shown in FIG. 13, the bare fibers 4b are eventually inserted smoothly and easily into the fiber holes 15f.

The ferrule 150 is constituted almost in the same way as the ferrule 15 except that the ferrule 150 does not have the cavity 15c and the guide grooves 15g. In FIG. 13, the same numerals are assigned to constitution elements of the ferrule 150 corresponding to those of the ferrule 15.

The following describes a ferrule according to a third embodiment.

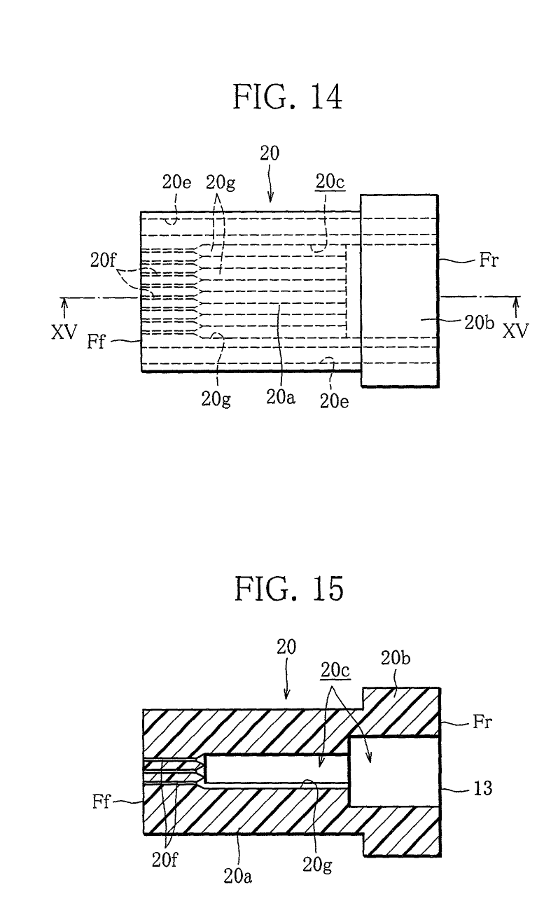

A ferrule 20 according to the third embodiment does not have an adhesive filler opening and a filler pit as shown in FIG. 14 and FIG. 15. The ferrule 20 is molded using the same synthetic resin as that used for the ferrule 10. The body 20a of the ferrule 20 has a front facet Ff and a rear facet Fr in the lengthwise direction. A collar 20b is formed on a rear part of the body 20a. The collar 20b is projected outward as a step from the outer surface more than the other part of the body 20a. An introduction opening 13 is formed on the rear facet Fr of the body 20a. A cavity 20c extending from the introduction opening 13 in the front-to-rear direction is formed approximately at the center of the body 20a. The cavity 20c communicates to multiple fiber holes 20f.

A pair of pin holes 20e are formed in the lengthwise direction in the body 20a. Guide pins are inserted into these pin holes 20e respectively. The 24 fiber holes 20f are formed in a front part of the body 20a between the two pin holes 20e. Optical fibers are inserted into the individual fiber holes 20f. The eight fiber holes 20f form one row, and three rows are piled up as three stages in the vertical direction to constitute a matrix array.

All the fiber holes 20f piled up as the three stages have the same length. The length is set to a range from ⅛ to ¾ of the overall length of the ferrule 20. Guide grooves 20g communicating to the fiber holes 20f on the bottom stage are formed in the body 20a. These guide grooves 20g extend from the fiber holes 20f toward the introduction opening 13. Ends communicating to the cavity 20c are formed at the same position with respect to the front-to-rear direction of the body 20a for all the fiber holes 20f on the second and upper stages, namely the middle and top stages, of the three stages of the fiber holes 20f. There are two stages where the ends of the fiber holes 20f are provided at the same position.

A connection facet (the front facet) of the ferrule is generally ground while the optical fibers are fixed to the individual fiber holes. Thus, it is necessary to set the length of the fiber holes 20f to ⅛ or more of the overall length of the ferrule 20 in terms of the quality of the ferrule 20 after the connection facet is ground. When the ferrule 20 is completed as an optical connector, a boot is attached to the rear end, and the optical fibers (fiber ribbon) extend from the rear end. Thus, it is necessary to secure ¼ or more of the overall length as a part for holding the boot and the optical fibers attached to the rear end in terms of capability for holding them. Consequently, it is necessary to set the length of the fiber holes 20f to ¾ or less of the overall length of the ferrule 20 in terms of the all aspects described above.

The optical fibers are fixed to the ferrule 20 using adhesive filled from the introduction opening 13 while the optical fibers are individually inserted into the multiple fiber holes 20f in the ferrule 20 constituted as described above, which is different in the way of filling from the ferrule 10 described above, and the ferrule 20 is assembled as an optical connector.

In the ferrule 20, the length of the fiber holes 20f piled up as the three stages is set to the range from ⅛ to ¾ of the overall length of the ferrule 20. Thus, as for the ferrule 10, because the resin pressure bends the core pins for the ferrule 20 more seldom than for the conventional ferrule 1 during the molding, the fiber holes 20f are formed at high precision. Simultaneously, the ferrule 20 does not have an opening such as the adhesive filler opening on the body 20a. Thus, even if there is a difference in coefficient of linear expansion between synthetic resin constituting the ferrule 20 and the adhesive, a generation of a warpage on the front facet Ff caused by an opening is restrained when the ferrule 20 is completed as an optical connector.

The following describes a ferrule according to a fourth embodiment.

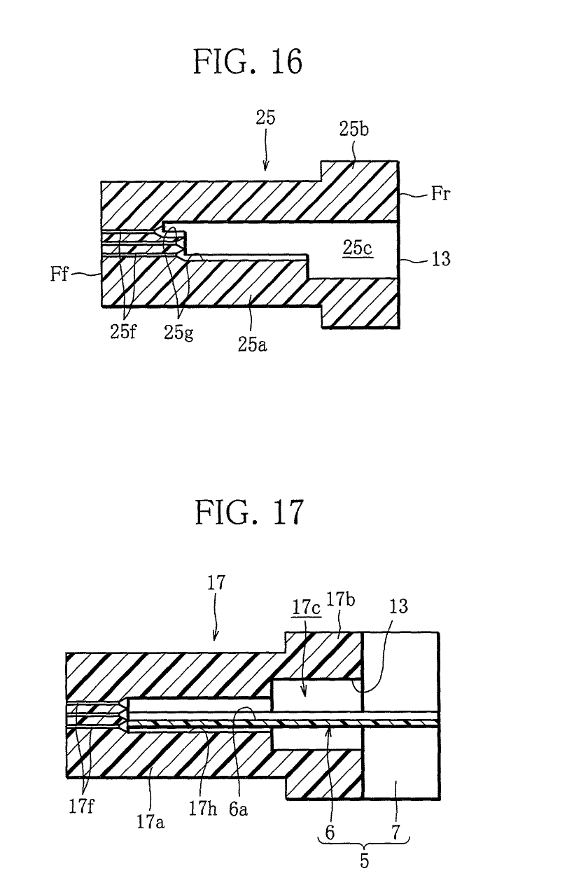

FIG. 16 shows a ferrule 25 according to the fourth embodiment. The body 25a of the ferrule 25 has a front facet Ff and a rear facet Fr respectively on the front and rear sides in the lengthwise direction. A collar 25b is formed on a rear part of the body 25a. The collar 25b is projected outward as a step from the outer surface more than the other part of the body 25a. An introduction opening 13 is formed on the rear facet Fr of the body 25a. A cavity 25c extending from the introduction opening 13 in the front-to-rear direction is formed approximately at the center of the body 25a. The cavity 25c communicates to multiple fiber holes 25f.

A pair of pin holes 25e are formed in the lengthwise direction in the body 25a. Guide pins are inserted into these pin holes 25e respectively. The 24 fiber holes 25f are formed in a front part of the body 25a between the two pin holes 25e. Optical fibers are inserted into the individual fiber holes 25f. The eight fiber holes 25f form one row, and three rows are piled up as three stages in the vertical direction to constitute a matrix array.

All the fiber holes 25f piled up as the three stages have a length from ⅛ to ¾ of the overall length of the ferrule 25. Guide grooves 25g are formed so as to communicate to the fiber holes 25f on the third stage from the bottom for guiding the optical fibers to the ends of these fiber holes 25f. Guide grooves 25g are formed so as to communicate to the fiber holes 25f on the bottom stage for guiding the optical fibers as shown in the drawing.

The ferrule 25 of the fourth embodiment has the following features for the positions of the fiber holes 25f communicating to the cavity 25c in the body 25a. Namely, the ends of the fiber holes 25f on an upper stage is closer to the front facet Ff than those on a lower stage for the fiber holes 25f on the second and upper stages, namely on the middle and top stages of the three stages. Simultaneously, there are at least two stages where the ends of the fiber holes 25f are provided at the same position in the front-to-rear direction of the body 25a.

The ferrule 25 constituted as described above is assembled as an optical connector as the ferrule 10. Since the ferrule 25 has the features described above in terms of the positions of the ends of the fiber holes 25f, the resin pressure bends core pins for the ferrule 25 more seldom than for the conventional ferrule 1 during the molding, and the fiber holes 25f are formed at high precision. Simultaneously, as the ferrule 20, because the ferrule 25 does not have a pit and an opening for filling adhesive, a generation of a warpage on the front facet Ff caused by an opening is restrained when the ferrule is completed as an optical connector.

When optical fibers are inserted into a ferrule which does not have a pit and an opening for filling adhesive as the ferrules according to the third and fourth embodiments, the applicator 5 described above especially provides an excellent feature.

FIG. 17 shows a ferrule almost similar to the ferrule according to the third embodiment. A pit and an opening for filling adhesive are removed from the ferrule 17 for increasing molding precision of fiber holes 17f as shown in FIG. 17. The body 17a is formed symmetrically in the vertical direction about a plane passing through the centers of the fiber holes 17f on a middle stage of three stages in the vertical direction. When the body 17a is formed into a shape symmetric in the vertical direction in this way, imbalance in shrink after the resin molding is avoided, and the molding precision of the fiber holes 17f is increased in the ferrule 17.

When the optical fibers 4 are being inserted into the fiber holes 17f of the ferrule 17, the operation for insertion is not conducted while the optical fibers 4 are visually observed through the adhesive filler opening 10d or 15d as for the ferrule 10 or 15 according to the first or second embodiment.

However, when the applicator 5 is used for the ferrule 17, the operation for inserting optical fibers is conducted as follows. First, an optical fiber is inserted from the introduction opening 13. The bare fiber (not shown) of the optical fiber is introduced into the cavity 17c while the base plate 6 placed on the top edges of guide grooves 17h is observed from the rear of the applicator 5, and the optical fiber is guided by the guide groove 6a. Since the bare fiber is guided by the guide groove 6a, and is smoothly and easily inserted into the fiber hole 17f, the workability increases during assembling the optical connector.

While the eight fiber holes are formed on the individual stages in any one of the ferrules according to the individual embodiments, there is no limitation on the number of the fiber holes. Also, there is no limitation on the stages for piling up the rows of the fiber holes either. The number of the stages may be two, or four or more.

In terms of the placement of the ends of the fiber holes for the ferrules of the individual embodiments, it is only necessary that the ends of the fiber holes on the second and the upper stages from the bottom, or the ends of the guide grooves which are on the second and the upper stages from the bottom, and neighbor each other in the vertical direction are placed at the same position with respect to the front-to-rear direction of the body. Thus, for the other guide grooves neighboring each other in the vertical direction, the guide grooves on a lower stage may be placed closer to the front facet than those on an upper stage. Inversely, the guide grooves on the upper stage may be placed closer to the front facet than those on the lower stage.

In terms of the applicators 5 and 10, there is no limitation on the number of the grooves 6a and 11a formed on the base plates 6 and 11. The number varies according to the number of the fiber holes in a ferrule to which the applicator is applied, and applications.

The application of the applicators is not limited to the inserting operation for the ferrule 15 of the second embodiment, the ferrule 150 which has the one stage of fiber holes 15f, and the ferrule 17 which has the three stages of fiber holes 17f. The applicators certainly provide a similar effect for the ferrules of the first, third, and the fourth embodiments, and ferrules which have two, or four or more stages of the fiber holes as for the ferrules described above.

What is claimed is:

1. A ferrule comprising:
a block-shaped body having a front facet and a rear facet;
two pin holes provided on said front facet, the two pin holes extending in a front-to-rear direction in said body for individually allowing a guide pin to be inserted thereinto;
a fiber hole array having multiple fiber holes provided between the two pin holes on said front facet, extending in the front-to-rear direction in said body, for individually allowing an optical fiber to be inserted thereinto and passed therethrough, the multiple fiber holes forming a row of the multiple fiber holes in a direction substantially in parallel with a direction of a line connecting centers of said two pin holes with each other, the multiple fiber holes forming multiple stages of these rows in a direction virtually perpendicular to the direction of the line connecting the centers of said two pin holes with each other;
an introduction opening formed on said rear facet, for introducing optical fibers;
a cavity extending from said introduction opening to inner ends of said multiple fiber holes in the front-to-rear direction of said body, for storing a part of said optical fibers;
an adhesive filler opening formed on a side surface of said body, for filling the inside of the body with an adhesive; and
a filler pit extending from said adhesive filler opening to the inside of said body to communicate to said cavity, for positioning said inner ends of said fiber holes on the second and upper stages in a range of said adhesive filler opening while said adhesive filler opening is viewed as the upper side.

2. A ferrule comprising:
a block-shaped body having a front facet and a rear facet;
two pin holes provided on said front facet, the two pin holes extending in a front-to-rear direction in said body for individually allowing a guide pin to be inserted thereinto;
a fiber hole array having multiple fiber holes provided between the two pin holes on said front facet, extending in the front-to-rear direction in said body, for individually allowing an optical fiber to be inserted thereinto and passed therethrough, the multiple fiber holes forming a row of the multiple fiber holes in a direction virtually in parallel with a direction of a line connecting centers of said two pin holes with each other, the multiple fiber holes forming multiple stages of these rows in a direction virtually perpendicular to the direction of the line connecting the centers of said two pin holes with each other;
an introduction opening formed on said rear facet, for introducing optical fibers;
a cavity extending from said introduction opening to inner ends of said multiple fiber holes in the front-to-rear direction of said body, for storing a part of said optical fibers;
guide grooves formed so as to communicate to said inner ends of said fiber holes in said cavity, for guiding the insertion of said optical fibers into said fiber holes;
an adhesive filler opening formed on a side surface of said body, for filling the inside of the body with an adhesive; and
a filler pit extending from said adhesive filler opening to the inside of said body to communicate to said cavity, for positioning said the ends of said guide grooves in a range of said adhesive filler opening while said adhesive filler opening is viewed as the upper side.

3. The ferrule according to claim 1, wherein
said inner ends of some of said fiber holes on second and upper stages from the bottom are placed at the same position in said filler pit while said adhesive filler opening is viewed as the upper side.

4. The ferrule according to claim 2, wherein
the ends of said guide grooves communicating to said inner ends of said fiber holes, and vertically neighboring each other on the second and upper stages from the bottom are placed at the same position in said filler pit while said adhesive filler opening is viewed as the upper side.

5. The ferrule according to claim 1, wherein
said inner ends of said fiber holes on second and upper stages are placed at the same position while said adhesive filler opening is viewed as the upper side.

6. The ferrule according to claim 2, wherein
the ends of said guide grooves communicating to said inner ends of said fiber holes, and vertically neighboring each other on the second and upper stages are placed at the same position while said adhesive filler opening is viewed as the upper side.

7. A ferrule comprising:
a block-shaped body having a front facet and a rear facet;
a pair of pin holes provided in said body, the pin holes extending in a front-to-rear direction in said body for individually allowing a guide pin to be inserted thereinto;
a fiber hole array having multiple fiber holes provided between said pair of pin holes in said body, each of the holes having an opening on one end on the front facet of said body, for individually allowing an optical fiber to be inserted thereinto and passed therethrough, the multiple fiber holes being vertically piled up to form stages;
a cavity extending from an introduction opening formed on the rear facet of said body toward the inside of said body, the cavity communicating to the other ends of said multiple fiber holes in said body, for allowing said optical fibers to be inserted thereinto through said introduction opening; and
guide grooves formed so as to communicate to said other ends of said fiber holes in said cavity, for guiding the insertion of said optical fibers into said fiber holes.

8. A ferrule comprising:
a block-shaped body having a front facet and a rear facet;
a pair of pin holes provided in said body, the pin holes extending in a front-to-rear direction in said body for individually allowing a guide pin to be inserted thereinto;
a fiber hole array having multiple fiber holes provided between said pair of pin holes in said body, each of the holes having an opening on one end on the front facet of said body, for individually allowing an optical fiber to be inserted thereinto and passed therethrough, the multiple fiber holes having an overall length set to a range from ⅛ to ¾ of an overall length of said body, the multiple fiber holes being vertically piled up to form stages;
a cavity extending from an introduction opening formed on the rear facet of said body toward the inside of said body, the cavity communicating to the other ends of said multiple fiber holes in said body, for allowing said optical fibers to be inserted thereinto through said introduction opening; and
a guide groove array having guide grooves formed so as to communicate to said other ends of said fiber holes in said cavity, for guiding the insertion of said optical fibers into said fiber holes, the guide grooves forming stages along with said fiber holes.

9. The ferrule according to claim 7, wherein
said other ends of said fiber holes on second and upper stages from the bottom are placed at the same position in said fiber hole array.

10. The ferrule according to claim 8, wherein
said ends of said fiber holes vertically neighboring each other on second and upper stages from the bottom in the fiber hole array are placed at the same position in said guide groove array.

11. The ferrule according to claim 7, wherein
said other ends of said fiber holes on second and upper stages from the bottom are placed at the same position in said fiber hole array.

12. The ferrule according to claim 8, wherein
said ends of said guide grooves with respect to said fiber holes vertically neighboring each other on second and upper stages from the bottom are placed at the same position in said fiber hole array.

13. An optical fiber applicator comprising:
a base plate including multiple guide grooves corresponding to fiber holes formed in a ferrule for optical connector; and
pin holders provided on both sides of said base plate, including an insertion hole for allowing a guide pin to be inserted through said ferrule.

14. The optical fiber applicator according to claim 13, wherein
one end of said base plate is projected from said pin holders.

15. The optical fiber applicator according to claim 13, wherein
said ferrule for optical connector includes a cavity for introducing optical fibers inside the ferrule, and
said base plate is inserted into said cavity.

16. The optical fiber applicator according to claim 15, wherein
said guide grooves are positioned so as to communicate to entrances of said fiber holes when said base plate is inserted into said cavity.

17. A method for inserting optical fibers comprising the steps of:
positioning an applicator including guide grooves for optical fibers with respect to a ferrule for optical connector including multiple fiber holes formed inside; and
inserting optical fibers into said fiber holes along said guide grooves.

18. The method for inserting optical fibers according to claim 17, wherein
guide pins to be inserted into said ferrule for optical connector are used to position said applicator.
